(19) United States
(12) Patent Application Publication
(10) Pub. No.: US 2011/0302814 A1
(43) Pub. Date: Dec. 15, 2011

(54) Picture frame assembly with water-resistant seal structure and kit and method for making same

(76) Inventor: Rod Kirkpatrick, Austin, TX (US)

(21) Appl. No.: 12/802,778

(22) Filed: Jun. 14, 2010

(51) Int. Cl. A47G 1/06; B23P 17/04

(52) U.S. Cl. 40/718; 29/428

(57) ABSTRACT

A frame assembly includes a seal structure configured for limiting the intrusion of water and the like into a displayed article (e.g., picture) receiving space thereof. The seal structure that provides a water-resistant barrier at front and rear openings of the displayed article receiving space of the frame assembly. In this manner, the frame assembly is well-suited for use in areas that are subject to the exposure to the elements, to being splashed with water, and/or being hit by flying objects thereby reducing the potential for being a safety risk, for damage to the frame and/or for damage to the displayed article.

### FIELD OF THE DISCLOSURE

The disclosures made herein relate generally to picture frames and framed pictures and, more particularly, to a frame assembly that provides a seal structure for limiting the intrusion of water and the like into a displayed article (e.g., picture) receiving space thereof.

### BACKGROUND

Various configurations of assemblies for displaying articles (e.g., paintings, sketches, lithographs, pictures, drawings, documents, collectibles, and the like) are well known in the art. A readily recognized example of such display assemblies is a wood bordered frame having a thin glass front pane, a mat border, a backboard, and a paper-backing sheet. Disadvantages of this configuration of frame assembly include, but are not limited to, the glass front pane being fragile and the displayed article being subject to damage when the frame assembly is exposed to moisture (e.g., rain, splashed water, sprayed water, high humidity, etc).

This type of frame assembly is not well suited for use in outdoor situations where exposure to the elements is possible, where exposure to splashed water is possible, and/or where inadvertent impact by flying objects is possible. For example, use of this type of frame assembly near an outdoor residential swimming pool may be desirable, but exposure to the elements, splashed water, and/or flying objects present a potential for being a safety risk, for risk of damage to the frame and/or for risk of damage to the displayed article. Therefore, a frame assembly that at least partially overcomes abovementioned and other known and/or yet to be discovered drawbacks associated with prior art frame assemblies would be advantageous, desirable and useful.

### SUMMARY OF THE DISCLOSURE

Embodiments of the present invention relate to a frame assembly including a seal structure configured for limiting the intrusion of water and the like into a displayed article (e.g., picture) receiving space thereof. More specifically, a frame assembly configured in accordance with the present invention includes a seal structure that provides a water-resistant barrier at front and rear openings of the displayed article receiving space of the frame assembly. In this manner, a frame assembly configured in accordance with the present invention is well-suited for use in areas that are subject to the exposure to the elements and/or to being splashed with water thereby reducing the potential damage to the frame and/or for damage to the displayed article. Thus, a skilled person will appreciate that a frame assembly configured in accordance with the present invention advantageously overcomes one or more shortcomings associated with frame assemblies that are not specifically configured for limiting the intrusion of water and the like into the displayed article receiving space thereof. Furthermore, frame assemblies configured in accordance with the present invention can utilize a shatter-resistance polymeric pane structure in place of a conventional glass panel, thereby reducing the potential of being a risk to safety.

In one embodiment of the present invention, a frame assembly for displaying an article comprises a frame, a displayed article stack, a seal structure, a backboard, and a barrier substrate. The frame has a displayed article receiving space extending through front and rear faces thereof. The frame has a ledge therein extending around the displayed article receiving space such that an opening defined at the rear face of the frame by the displayed article receiving space is larger than an opening defined at the front face of the frame by the displayed article receiving space. The displayed article stack includes a transparency panel and a displayed article in stacked arrangement. The displayed article stack is disposed within the rear face opening with a front face of the transparency panel facing toward the ledge and a rear face of the transparency panel facing toward a front face of the displayed article. The seal structure extends along substantially an entire length of the ledge in engagement between the front face of the transparency panel and the ledge. The backboard is disposed within the rear face opening. A front face of the backboard faces toward a rear face of the displayed article. The barrier substrate is attached to a rear face of the backboard. The barrier substrate is resistant to transmission of water therethrough. A width of the barrier substrate is greater than a width of the rear face opening such that the barrier substrate extends over opposing side edges of the rear face opening of the frame. A top edge portion of the barrier substrate is attached to the rear face of the frame above a top edge of the rear face opening of the frame such that the barrier substrate forms a water-resistant hinge between the backboard and the frame.

In another embodiment of the present invention, a method of fabricating a frame assembly for displaying an article comprises a plurality of operation. An operation is performed for providing a frame having a displayed article receiving space extending through front and rear faces thereof. The frame has a ledge therein extending around the displayed article receiving space such that an opening defined at the rear face of the frame by the displayed article receiving space is larger than an opening defined at the front face of the frame by the displayed article receiving space. An operation is performed for providing a seal structure along substantially an entire length of the ledge and an operation is performed for positioning a displayed article stack within the rear face opening of the frame such that a front face of a transparency panel of the displayed article stack is engaged against the seal structure. Thereafter an operation is performed for positioning a backboard within the rear face opening over the displayed article stack. A front face of the backboard is engaged against the displayed article stack, An operation is performed for attaching an upper portion of a barrier substrate to the rear face of the frame only above a top edge of the rear face opening of the frame and a lower portion of the barrier substrate to a rear face of the backboard. The barrier substrate is resistant to transmission of water therethrough such that the barrier substrate forms a water-resistant hinge between the backboard and the frame. A width of the barrier substrate is greater than a width of the rear face opening such that the barrier substrate extends over opposing side edges of the rear face opening of the frame. The seal structure can be attached to the front face of the transparency panel whereby providing the seal structure along substantially the entire length of the ledge is performed in conjunction with positioning a displayed article stack within the rear face opening of the frame. Alternatively, the seal structure can be includes an adhering substance on a surface thereof engaged with a surface of the ledge whereby providing the seal structure along the entire length of the ledge includes adhering the adhering substance to the ledge.

In another embodiment of the present invention, a kit is provided for fabricating a water resistant frame assembly for displaying an article. The kit is configured for use with a frame having a displayed article receiving space extending through front and rear faces thereof and having a ledge therein extending around the displayed article receiving space such that an opening defined at the rear face of the frame by the displayed article receiving space is larger than an opening defined at the front face of the frame by the displayed article receiving space. The kit comprises a seal structure and a barrier substrate. The seal structure is of sufficient length to be extended along substantially an entire length of the ledge of the frame. The seal structure is engagable between the ledge and a front face of a transparency panel of a displayed article stack for forming a water-resistance seal therebetween. The barrier substrate is resistant to transmission of water therethrough. A width of the barrier substrate is greater than the width of the rear face opening of the frame thereby allowing the barrier substrate to extends over opposing side edges of the rear face opening of the frame. An adhering substance is provided along an upper portion and a lower portion of the barrier substrate between opposing side edges thereof for allowing the barrier substrate to form a water-resistant hinge between the frame and a backboard disposed within the rear face opening when the adhering substance at the upper portion of the barrier substrate is engaged with the rear face of the frame and the adhering substance at the lower portion of the barrier substrate is engaged with the backboard.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a perspective view showing frame assembly in accordance with an embodiment of the present invention;

FIG. 2 is a rear view of the frame assembly shown in FIG. 1;

FIG. 3 is a cross-sectional view taken along the line 3-3 in FIG. 1; and

FIG. 4 is perspective view showing a kit for fabricating a water resistant frame assembly in accordance with an embodiment of the present invention, wherein a release liner is partially cut away to show an underlying adhering substance.

### DETAILED DESCRIPTION

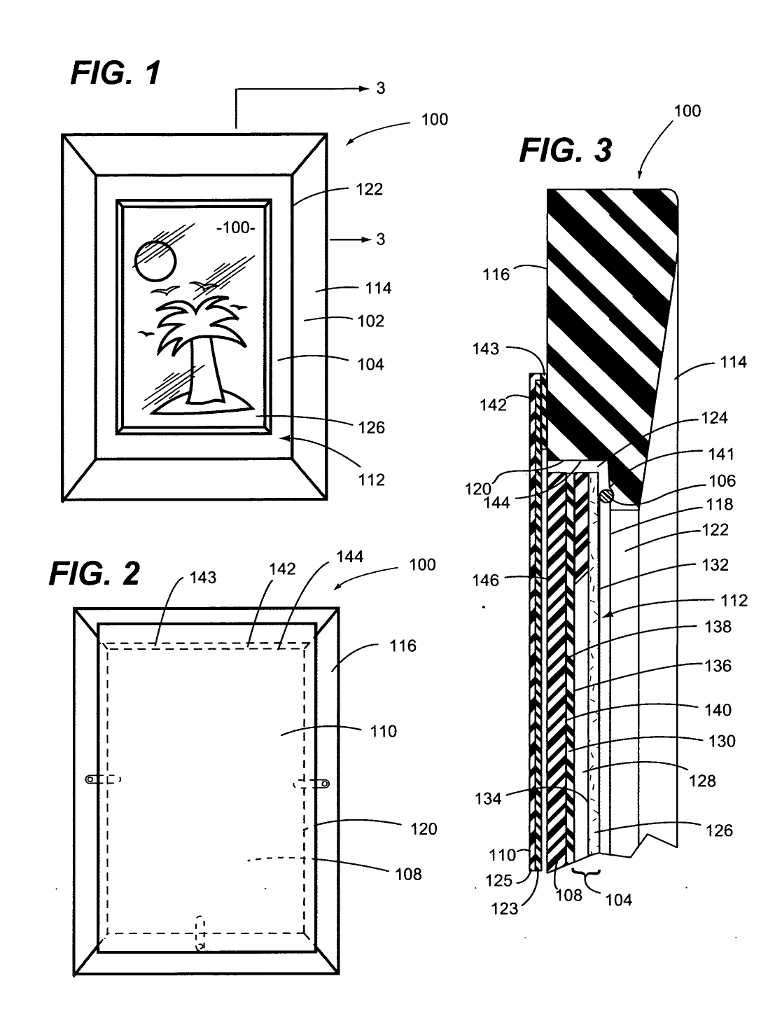

FIGS. 1-3 show various aspects of a frame assembly 100 configured in accordance with an embodiment of the present invention. The frame assembly 100 provides a sealing arrangement that limits the intrusion of water and the like into a displayed article (e.g., picture) receiving space thereof In this manner, the frame assembly 100 is well-suited for use in areas that are subject to the exposure to the elements and/to being splashed with water thereby reducing the potential for damage to the frame and/or for damage to the displayed article. Thus, a skilled person will appreciate that a frame assembly configured in accordance with the present invention advantageously overcomes one or more shortcomings associated with frame assemblies that are not specifically configured for limiting the intrusion of water and the like into the displayed article receiving space thereof.

The frame assembly 100 includes a frame 102, a displayed article stack 104, a seal structure 106, a backboard 108, and a barrier substrate 110. The frame 102 has a displayed article receiving space 112 extending through a front face 114 and a rear face 116 thereof. The frame 102 has a ledge 118 therein extending around the displayed article receiving space 112 such that an opening defined at the rear face 116 of the frame 102 by the displayed article receiving space 112 (i.e., the rear face opening 120) is larger than an opening defined at the front face 114 of the frame 102 by the displayed article receiving space 112 (i.e., the front face opening 122).

The ledge 118 defines what is known in the art as a “rabbet”. A rabbet is a recess 124 exposed at a back face of the frame 102 where the displayed article stack 104 is received. Preferably, but not necessarily, the backboard 108 can also be received in this recess. The rabbet depth is important in selecting a frame because it is desirable to have a rabbet deep enough to accept a displayed article stack and backboard so that they will fit level with or below a rear face of the frame. In general, frame contents consisting of glass, single mat, artwork and backboard (e.g., foamboard) will require about a ⅜″ deep rabbet. The rabbet depth will need to increase accordingly for additional mat layers. Furthermore, for a typical stretched canvas artwork, a rabbet depth of 1½″ or more can be required.

The displayed article stack 104 will typically include a transparency panel 126 (e.g., glass or polymeric material), one or more mats 128, and one or more displayed articles 130 in stacked arrangement. The displayed article stack 104 is disposed through the rear face opening 120 with a front face 132 of the transparency panel 126 facing toward the ledge 118 and a rear face 134 of the transparency panel 126 facing toward a front face 136 of the displayed article 130.

Examples of suitable material for the transparency panel 126 include, but are not limited to, glass, polycarbonate, acrylic, and other suitable transparent or semi-transparent materials. It is disclosed herein that the transparency panel 126 can include a material composition thereon or therein for limiting exposure of the underlying components of the displayed article stack 104 to harmful components of ambient and/or artificial light. For example, a surface of the transparency panel 126 can be coated with a material composition that reduces the transmission of ultraviolet light through the transparency panel 126. Mats can be paper-based products, polymeric, or the like. It is disclosed herein that embodiments of the present invention are not unnecessarily limited to any particular type of transparency panel, mat, displayed article, or backboard.

The seal structure 106 extends along substantially an entire length of the ledge 118 in engagement between the front face 132 of the transparency panel 126 and the ledge 118. The backboard 108 is disposed within the rear face opening 120. A front face 138 of the backboard 108 faces toward a rear face 140 of the displayed article 130. Examples of the seal structure 106 include, but are not limited to, a preformed gasket, an O-ring seal, a length of sealing strip material, and the like. The frame 102 can include a groove 141 within the ledge 118 extending around the displayed article receiving space 112 for allowing the seal structure 106 to be disposed within the groove 141.

In one embodiment, the sealing structure 106 can include an adhering substance on a surface thereof engagable with the front face 132 of the transparency panel 126, on a surface thereof engagable with the ledge 118, or both. In this manner, the sealing structure 106 can be configured for allowing the seal structure to be adhered to the front face 132 of the transparency panel 126, to the ledge 118, or both. In the case where the adhering substance needs to be protected from contamination and/or unintentional activation, a removable protective material such as a release line can be provided over the adhering substance until it is ready to be adhered.

A top edge portion 142 of the barrier substrate 110 is attached to the rear face 116 of the frame 102 above a top edge 144 of the rear face opening 120 of the frame 102 via a strip of adhesive 143 or other suitable bonding/adhering substance. A width of the barrier substrate 110 is greater than a width of the rear face opening 120 such that the barrier substrate 110 extends over opposing side edges (i.e., vertically extending edges) of the rear face opening 120. In this manner, a water-resistant interface is provided between the frame 102 and the barrier substrate 110 and potential for exposure of the opposing side edges of the rear face opening 120 to water flowing down from the top of the frame 102 is dramatically reduced as the barrier substrate forms a curtain over the rear face opening 120. In one embodiment, the barrier substrate 110 can also be adhered to substantially an entire portion of the rear face 146 of the backboard 108.

Preferably, but not necessarily, the barrier substrate 110 includes a layer of material that is resistant to transmission of water therethrough. A polymeric sheet material such as that offered under the trademark of TYVEK is an example of such a suitable material. In one embodiment, the barrier substrate 110 can include a stiffening layer 123 (e.g., stiff board/sheet material) and a barrier layer 125 (e.g., TYVEK) attached to the stiffening layer 123. The stiffening layer 123 can be substantially flat and substantially stiff, the barrier layer 125 can be substantially pliant, and the stiffening layer 123 is disposed between the backboard 108 and the barrier layer 125. Alternatively, the barrier substrate 110 can be formed from a single layer of material (e.g., a single layer of TYVEK).

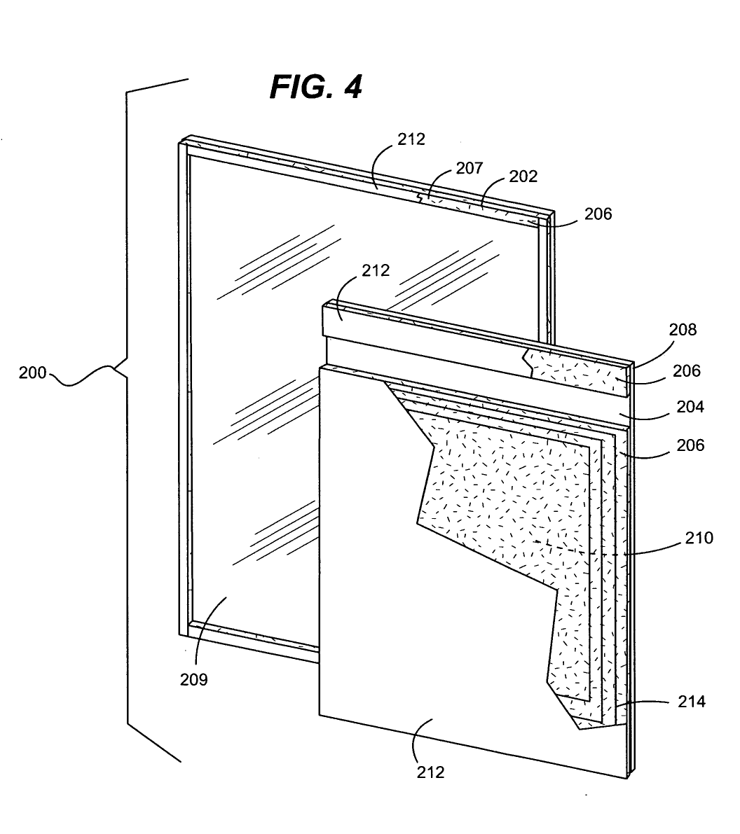

Referring to FIG. 4, a kit 200 for fabricating a water resistant frame assembly for displaying an article is shown. The kit 200 is configured for use with a frame having a displayed article receiving space extending through front and rear faces thereof and having a ledge therein extending around the displayed article receiving space such that an opening defined at the rear face of the frame by the displayed article receiving space is larger than an opening defined at the front face of the frame by the displayed article receiving space (e.g., the frame 102 discussed above in reference to FIGS. 1-3).

The kit 200 includes a seal structure 202 and a barrier substrate 204. The seal structure 202 is of sufficient length to be extended along substantially an entire length of the ledge of the frame and is configured for being engaged between the ledge and a front face of a transparency panel of a displayed article stack for forming a water-resistance seal therebetween. The barrier substrate 204 is resistant to transmission of water therethrough. A width of the barrier substrate 204 is greater than the width of the rear face opening of the frame thereby allowing the barrier substrate 204 to extends over opposing side edges of the rear face opening of the frame.

An adhering substance 206 (e.g. pressure-sensitive adhesive) is provided along an upper edge portion 208 and a central portion 210 of the barrier substrate 204 between opposing side edges thereof for allowing the barrier substrate 204 to form a water-resistant hinge between the frame and a backboard disposed within the rear face opening when the adhering substance 206 at the upper edge portion 208 of the barrier substrate 204 is engaged with the rear face of the frame and the adhering substance 206 at the lower portion 210 of the barrier substrate 204 is engaged with the backboard. A protective release liner 212 can be releaseably engaged over the adhering substance 206.

In one embodiment, the seal structure 202 can includes an adhering substance 207 on a surface thereof engagable with the front face of the transparency panel, a surface thereof engagable with the ledge, or both surfaces. A protective release liner 212 can be releaseably engaged over the adhering substance 207. As disclosed above, the barrier substrate can include a stiffening layer and a barrier layer attached to the stiffening layer with the stiffening layer being substantially flat and substantially stiff and the barrier layer being substantially pliant. It is also disclosed herein that, in one specific embodiment (shown in FIG. 4), the kit 200 can include a transparency panel 209 having the seal structure 202 attached (e.g., via an adhering substance) around a perimeter edge portion thereof. Preferably, but not necessarily, the transparency panel 209 is a shatter-resistance panel (e.g., made from a polymeric material such as polycarbonate) and can include a material composition thereon or therein for limiting exposure of the underlying components of a displayed article stack to harmful components of ambient and/or artificial light.

In one embodiment, the barrier substrate 204 can include backboard placement indicia 214 on the central portion thereof on the same side thereof as the adhering substance 206 at the upper edge portion 208 thereof This backboard placement indicia 214 can be in the form of imprinted rectangular shapes that are uniformly spaced between opposing side edges of the barrier substrate 204. In one embodiment, the adhering substance 206 on the central portion 210 of the barrier substrate 204 can be provided at least partially over the backboard placement indicia 214 in a manner allowing the backboard placement indicia 214 to be visible through the adhering substance 206. In another embodiment, the backboard placement indicia 214 can be provided (e.g., printed) on top of the adhering substance 206 on the central portion 210 of the barrier substrate 204. Advantageously, the backboard placement indicia 214 allows for suitable placement of a backboard when attaching the backboard to the barrier substrate 204 (e.g., approximately equidistant between opposing side edges of the barrier substrate 204).

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

What is claimed is:

1. A frame assembly for displaying an article, comprising:
a frame having a displayed article receiving space extending through front and rear faces thereof, wherein the frame has a ledge therein extending around the displayed article receiving space such that an opening defined at the rear face of the frame by the displayed article receiving space is larger than an opening defined at the front face of the frame by the displayed article receiving space;
a displayed article stack including a transparency panel and a displayed article in stacked arrangement, wherein the displayed article stack is disposed within said rear face opening with a front face of the transparency panel facing toward the ledge and a rear face of the transparency panel facing toward a front face of the displayed article;
a seal structure extending along substantially an entire length of the ledge in engagement between the front face of the transparency panel and the ledge;
a backboard disposed within said rear face opening, wherein a front face of the backboard faces toward a rear face of the displayed article; and
a barrier substrate has a top edge portion thereof attached to a rear face of the frame above a top edge of said rear face opening of the frame, wherein the barrier substrate is resistant to transmission of water therethrough, wherein a width of the barrier substrate is greater than a width of said rear face opening such that the barrier substrate extends over opposing side edges of said rear face opening of the frame.

2. The frame assembly of claim 1 wherein the barrier substrate is attached to the frame only above the top edge of said rear face opening of the frame and is attached to the backboard such that the barrier substrate forms a water-resistant hinge between the backboard and the frame.

3. The frame assembly of claim 1 wherein:
the frame includes a groove within the ledge extending around the displayed article receiving space; and
the seal structure is disposed within the groove.

4. The frame assembly of claim 1 wherein the seal structure includes an adhering substance on at least one of a surface thereof engaged with the front face of the transparency panel and a surface thereof engaged with the ledge thereby adhering the seal structure to at least one of the front face of the transparency panel and the ledge.

5. The frame assembly of claim 1 wherein the barrier substrate overlies and is adhered to substantially an entire portion of the rear face of the backboard.

6. The frame assembly of claim 1 wherein:
the barrier substrate includes a stiffening layer and a barrier layer attached to the stiffening layer;
the stiffening layer is substantially flat and substantially stiff;
the barrier layer is substantially pliant; and
the stiffening layer is disposed between the backboard and the barrier layer.

7. The frame assembly of claim 6 wherein:
the stiffening layer overlies and is adhered to substantially an entire portion of the rear face of the backboard; and
the barrier layer overlies and is adhered to substantially an entire portion of the rear face of the backboard.

8. The frame assembly of claim 7 wherein the seal structure includes an adhering substance on at least one of a surface thereof engaged with the front face of the transparency panel and a surface thereof engaged with the ledge thereby adhering the seal structure to at least one of the front face of the transparency panel and the ledge.

9. The frame assembly of claim 8 wherein:
the frame includes a groove within the ledge extending around the displayed article receiving space; and
the seal structure is disposed within the groove.

10. The frame assembly of claim 7 wherein the barrier substrate is attached to the frame only above the top edge of said rear face opening of the frame and is attached to the backboard such that the barrier substrate forms a water-resistant hinge between the backboard and the frame.

11. A method of fabricating a frame assembly for displaying an article, comprising:
providing a frame having a displayed article receiving space extending through front and rear faces thereof, wherein the frame has a ledge therein extending around the displayed article receiving space such that an opening defined at the rear face of the frame by the displayed article receiving space is larger than an opening defined at the front face of the frame by the displayed article receiving space;
providing a seal structure along substantially an entire length of the ledge;
positioning a displayed article stack within said rear face opening of the frame, wherein a front face of a transparency panel of the displayed article stack is engaged against the seal structure;
positioning a backboard within said rear face opening over the displayed article stack, wherein a front face of the backboard is engaged against the displayed article stack; and
attaching an upper portion of a barrier substrate to the rear face of the frame only above a top edge of said rear face opening of the frame and a lower portion of the barrier substrate to a rear face of the backboard, wherein the barrier substrate is resistant to transmission of water therethrough such that the barrier substrate forms a water-resistant hinge between the backboard and the frame and wherein a width of the barrier substrate is greater than a width of said rear face opening such that the barrier substrate extends over opposing side edges of said rear face opening of the frame.

12. The method of claim 11 wherein:
the seal structure is attached to the front face of the transparency panel; and
providing the seal structure along substantially the entire length of the ledge is performed in conjunction with positioning a displayed article stack within said rear face opening of the frame.

13. The method of claim 11 wherein:
the frame includes a groove within the ledge extending around the displayed article receiving space; and
providing the seal structure along the entire length of the ledge includes positioning the seal structure within the groove.

14. The method of claim 11 wherein:
the seal structure includes an adhering substance on a surface thereof engaged with a surface of the ledge; and
providing the seal structure along the entire length of the ledge includes adhering the adhering substance to the ledge.

15. The method of claim 14 wherein:
the frame includes a groove within the ledge extending around the displayed article receiving space; and
providing the seal structure along an entire length of the ledge includes positioning the seal structure within the groove.

16. The method of claim 15 wherein:
the seal structure is attached to the front face of the transparency panel; and
providing the seal structure along substantially the entire length of the ledge is performed in conjunction with positioning a displayed article stack within said rear face opening of the frame.

17. A kit for fabricating a water resistant frame assembly for displaying an article, wherein the kit is configured for use with a frame having a displayed article receiving space extending through front and rear faces thereof and having a ledge therein extending around the displayed article receiving space such that an opening defined at the rear face of the frame by the displayed article receiving space is larger than an opening defined at the front face of the frame by the displayed article receiving space, the kit comprising:
a seal structure of sufficient length to be extended along substantially an entire length of the ledge of the frame, wherein the seal structure is engagable between the ledge and a front face of a transparency panel of a displayed article stack for forming a water-resistance seal therebetween; and
a barrier substrate resistant to transmission of water therethrough, wherein a width of the barrier substrate is greater than the width of said rear face opening of the frame thereby allowing the barrier substrate to extends over opposing side edges of said rear face opening of the frame and wherein an adhering substance is provided along an upper edge portion of the barrier substrate between opposing side edges thereof for allowing the barrier substrate to form a water-resistant interface between the frame and the barrier substrate when the adhering substance at the upper edge portion of the barrier substrate is engaged with the rear face of the frame.

18. The kit of claim 17, further comprising:
the transparency panel, wherein the seal structure is attached to the front face of the transparency panel around a perimeter edge portion thereof and wherein the transparency panel is a shatter-resistant transparency panel made from a polymeric material.

19. The kit of claim 17 wherein the seal structure includes:
an adhesive on a surface thereof engagable with the ledge; and
a protective release liner releaseably engaged over said sealing structure adhesive.

20. The kit of claim 17 wherein:
the barrier substrate includes backboard placement indicia on a central portion thereof on the same side thereof as the adhering substance at the upper edge portion thereof; and
an adhering substance is provided at least partially over the backboard placement indicia in a manner allowing the backboard placement indicia to be visible through the adhesive substance on the central portion of the backboard.
